(19) United States
(12) Patent Application Publication
(10) Pub. No.: US 2004/0243471 A1
(43) Pub. Date: Dec. 2, 2004

(54) Process and system for authoring electronic information by filling in template pattern with local presentation information

(76) Inventors: Larry J. Salmen, Fort Collins, CO (US); Paul F. Knight, Fort Collins, CO (US); Steven W. Ulrich, Fort Collins, CO (US); Scott F. Porter, Portland, OR (US)

Correspondence Address: JEAN M. MACHELEDT, 501 SKYSAIL LANE, SUITE B100, FORT COLLINS, CO, 80525-3133, US

(21) Appl. No.: 10/623,363

(22) Filed: Jul. 17, 2003

Related U.S. Application Data
(60) Provisional application No. 60/396,965, filed on Jul. 17, 2002.

(51) Int. Cl. G06F 17/60

(52) U.S. Cl. 705/15; 705/26

(57) ABSTRACT

A technique, system, and program code for authoring electronic information for presentation at an interactive electronic display with which an item may be ordered; core features include utilizing at least a first template default pattern, group information associating at least one cell to each of a plurality of identified groups, and local presentation information associating each of a plurality of presentation objects with at least one of the identified groups, to fill-in the cells of the pattern with one or more of the presentation objects. A DIALOG template may be provided containing the first template, as well as additional templates, each defining respective default patterns. To organize various types of information intended for presentation at an interactive device, each default pattern of each template is preferably associated with a respective parent group(ing). Further grouping may be done by identifying one or more subgroup(ing)s each tied, for example, to a display area within a default pattern/parent group. At least one cell may be associated with each subgroup, although more than one cell may be so associated depending upon layout of that subgroup's display area.

This application claims priority to pending U.S. provisional patent application No. 60/396,965 filed 17 Jul. 2002 on behalf of the assignee hereof.

### BACKGROUND OF THE INVENTION

1. Field of the Invention

In general, the present invention relates to processes and systems that can offer for sale, items (both wholesale and retail prepared fast-food, packaged foods, dry goods, and other consumer products, whether consumable), in a self-service fashion using a touch-screen display, computer-peripheral key board or keypad, telephone key-pad or receiver, mouse/pointing device, microphone, or other electronic device capable of accepting and transmitting a customer's input.

2. Background of the Invention

More-particularly, applicants' invention is directed to a unique upgraded authoring technique, system, and associated program code that use a template defining a default pattern for which cell associations are made employing a group information data structure, combined with a local presentation information data structure, associating presentation objects (associated with items) with groups identified by the group information data structure, in a manner such that cells of the template pattern can be filled-in with respective presentation objects for the presenting at an interactive device. One or more of the template default patterns may originate as part of a complex DIALOG multimedia, multisensory template presentation created at, for example, a host product support center or corporate or regional headquarters of a chain of sales outlets. The local presentation information data structure may be generated using information from an ‘in-store’ menu database containing items intended for sale, such as a listing of IDstrings, common names, “price look-up” (PLU) or other code(s), along with a variety of presentation objects, one or more of which are associated with identified group(ing)s from the group information data structure. Each item intended for presentation will have at least one presentation object associated with it. The hierarchical grouping into parent groups and various levels of subgroups of cells by the group information data structure provides a means by which presentation objects of a local presentation information data structure can be associated with, or mapped into, the template (default) pattern to fill-in cells with the selected object for the tailor-made presentation. The local presentation information may be generated at any outlet with suitable computer processing, memory and storage capability, whether it be physically located at corporate headquarters, chain regional office, local division, or even at the “point of sale” (POS) outlet at which items are offered for sale. Once a tailor-made presentation has been produced utilizing any template pattern(s) selected and intermediary display patterns (if created, and as selected), group information as edited (if at all), and local presentation information (including any cell characteristic(s) overrides due to overlapping data with the group information), it can be further configured for use on an interactive device at the outlet (such as a store, shop counter, restaurant, kiosk, cart, or any other “point of access” at which items are offered for sale).

A multi-national corporation in the business of selling consumer products, especially one that owns many sales outlets, may have millions of interactions each day between customers and company sales clerks. In order to increase sales, yet contain costs, many of these corporations are interested in decreasing their large number of daily in-person customer-clerk interactions by offering goods for sale through electronic devices, such as customer activated terminals (both on-and off-site), home personal computers (connected with the Internet), televisions (connected to cable TV channels via hardwire or satellite dish), and telephones. With the increased use of electronic devices, a demand for flexible techniques that can automatically deliver tailor-made multimedia presentations and permit timely updates to presentations, as well as accept customer orders, remains strong.

The assignee hereof has designed and implemented an earlier process and computer system for configuration, as well as transmission via modem to each restaurant, of outlet-specific multi-media presentations for fast-food customer activated touch-screen terminals. Heavy service and software support, especially manual updating and tracking of outlet presentations, is necessary for these processes and systems. Typical in-store hardware currently used for transmitting and presenting a store-specific multi-media display of fast-food items for sale to a customer at a terminal (into which the customer can place an order), is shown in FIG. 1. Generating restaurant-specific presentations, as well as generating and tracking updates to restaurant-specific presentations, remains highly labor-intevsive: as the complexity of a presentation increases to include complex text, audio, still- and motion-graphics, video, as well as presentation objects having additional multisensory attributes of taste and smell; as the number of items (including constituent components, condiments, as well as nonconsumable items) being offered at an electronic device increases; as the number of outlets increases, thus increasing the number of store-specific presentations; and as the number of updates or changes to store-specific presentations increases. Reference is made throughout to U.S. Pat. No. 5,806,071 ('071) to Balderrama, et al., “Process and System for Configuring Information for Presentation at an Interactive Electronic Device”, issued 8 Sep. 1998 to the assignee hereof (with two common applicants hereof), the specification and drawings of which are fully incorporated herein by reference for purposes of providing technical background discussion support of features and system components.

Applicants have developed a unique authoring technique that may be used in conjunction with their configuration process (please see '071) to provide an overall enhancement to the project to create presentations for offering items for sale at interactive devices. The new authoring technique illustrates a design shift from the earlier item-focused configuration of lists. The new technique provides a mechanism by which additional access to components used to author a presentation may be given without permitting modification to the fundamental structure of display pattern content or presentation (‘flow’) of displays; there is preferably no opportunity for in-store personnel to access and modify the fundamental process of reading template patterns and accessing group and local presentation information, to author a presentation. Applicants' new design to provide additional access to the components of a presentation—during the process of authoring—includes the capability(ies) to provide different access-levels of restriction to records of the information data structures; thus, giving greater flexibility to tailor and update a presentation to corporate headquarters, regional divisions, in-store, etc., personnel. The task to generate and update tailor-made presentations for interactive devices at which an item may be ordered has been enhanced. Thus, and according to the invention, a very unique approach is outlined herein as supported by computer engineering analyses performed by the applicants. Applicants have discovered a technique for authoring electronic information for presentation at an interactive electronic display with which an item may be ordered that utilizes at least a first template default pattern, group information associating at least one cell to each of a plurality of identified groups, and local presentation information associating each of a plurality of presentation objects with at least one of the identified groups, to fill-in the cells of the pattern with one or more of the presentation objects. The unique authoring technique and system of the invention utilizes a template default pattern, which may be part of DIALOG template file(s), that need not anticipate and include specific item(s) intended for sale via the presentation at an interactive device.

### General Background Discussion, Provided by Way of Reference

I. Digital computers. The central processing unit (CPU) is considered the computing part of a digital or other type of computerized system. Sometimes referred to simply as a processor, a CPU is made up of the control unit and an arithmetic logic unit (ALU)—a high-speed circuit that does calculating and comparing. Numbers are transferred from memory into the ALU for calculation, and the results are sent back into memory. Alphanumeric data is sent from memory into the ALU for comparing. As is well known, the basic elements of a computer include CPU, clock and main memory; a complete computer system requires the addition of control units, input, output and storage devices, as well as an operating system. Once the data is in a computer's memory, the computer can process it by calculating, comparing and copying it; generally understood as follows: calculating—performing any mathematical operation on data by adding, subtracting, multiplying and dividing one set with another; comparing—analysis and evaluation of data by matching it with sets of known data that are included in a program or called in from storage; and coping—the moving of data around to create reports or listing, etc., in a selected order. For each data record, there are typically many fields that hold instances of data that relate to the record. Data elements are basic units of storage providing a logical definition of the field; fields are the physical storage units (typically at least one byte in size) that hold the instances of data. Objects contain blocks or modules of data.

II. Computer Memory and Computer Readable Storage. While the word ‘memory’ generally refers to that which is stored temporarily, storage is traditionally used to refer to a semi-permanent or permanent holding place for digital data—such as that entered by a user for holding long term. A non-exhaustive listing of known computer readable storage device technologies are categorized here for reference: (1) magetic tape technologies include QIC (minicartridges and larger data cartridges, such as those supplied by Imation Corp.), DAT 4 mm cartridges, Exabyte Corp.'s 8 mm tape cartridges, and so on; (2) magnetic disk technologies include floppy disk/diskettes, fixed hard disks (such as those in personal desktops, laptops, workstations, supercomputers, etc.), Iomega Corp.'s brand name ZIPS®, HIPZIP®, JAZ®, and PEERLESS® disks, and so on; (3) optical disk technology includes magneto-optical disks, PD, CD-ROM, CD-R, CD-RW, DVD-ROM, DVD-R, DVD-RAM, WORM, OROM, holographic, solid state optical disk technology distributed by a wide variety of companies, and so on.

### SUMMARY OF THE INVENTION

It is a primary object of this invention to provide a technique and system for authoring electronic information for presentation at an interactive electronic display with which an item may be ordered. Once again, the unique technique, system and program code disclosed and supported herein utilize at least a first template default pattern, group information associating at least one cell to each of a plurality of identified groups, and local presentation information associating each of a plurality of presentation objects with at least one of the identified groups, to fill-in the cells of the pattern with one or more of the presentation objects. The nature of applicants' new authoring technique and system provides control over basic template pattern structure to remain within a central location where trained support staff can maintain program code, yet permits flexibility and options for adding or modifying items as well as creating and editing cell characteristics (cell function, multisensory attributes, and cell layout pattern—shape, size, and relative location of any cell within a defined display area), based upon a level of permitted access prior to filling-in cells with presentation objects for presentation at the interactive display. In addition, new items can be offered for (or removed from) sale and configured into the presentation given at the interactive device without requiring corporate headquarters, regional division, etc., authorization or specifying, ahead of time, the new items. The interactive presentation will be used by at a local/localized facility having an interactive electronic display, whether as part of a kiosk, computer system client device, handheld unit, etc., such as one located ‘in-store’, for example, at the front door, near a front desk, self-standing, attached to another structure, along the path of or at a drive-through order window, or within any restaurant, outlet, shop, hotel/motel, grocery store, mall, bank/financial institution, airport, bus/train station, library, government building or access, as well as other public or private facilities where items may be ordered.

As one will appreciate, certain of the several unique features, and further unique combinations of features, as supported and contemplated hereby may provide a variety of advantages including versatility in application; providing additional useful functionalities; speed, flexibility and efficiency in authoring and modifying new presentations; permitting reliable multimedia display information to be communicated to a user at a point-of-sale location; and so on. Thus, the mapping of items to locations in a final presentation may be done at the retail outlet, as desired. This and other advantages of providing the new process, associated system and program code, will be appreciated by perusing the instant technical discussion, including the drawings, claims, and abstract, in light of drawbacks to any existing sensing network technology that have been identified, or may be uncovered.

The invention includes a process, system and computer executable program code on a computer readable storage medium, for authoring electronic information for presentation at an interactive electronic display with which an item may be ordered. The method, as well as the associated system and code, incorporates many patentably distinguishing features, as described here: providing a first template defining a default pattern; providing group information comprising data records associating at least one cell to each of a plurality of identified groups; providing local presentation information comprising data records associating each of a plurality of presentation objects with at least one of the identified groups; and reading the default pattern along with accessing group information and local presentation information, filling-in the cells. The group information and the local presentation information are preferably organized as separate data structures, such as in table or linked list format, and so on. Item, as used throughout may be any whole, partial, component/subcomponent, etc., of any physical manifestation of a product/good or service which may be ordered. Within the wholesale and retail food/grocery/restaurant industry, a majority of items are ordered for consumption or to support the consumption of another item (e.g., a utensil, napkin, condiment, container/receptacle, spice, gift card/certificate, etc.); nevertheless, and as used herein, item includes any item (whole, partial, component, etc.) traditionally considered nonconsumable, as well.

Presentation objects preferably each comprise at least one module of data having multisensory attributes. “Multisensory attribute(s)” as used herein, references any information provided by the cell which can be received by any one or more of the human senses of vision, hearing, touch, smell or taste. All types of object data modules having one or more multisensory attribute are contemplated herein including, by way of example, text, icon (still or animated), a graphic (whether still or animated, simple or complex, such as a line, table, shape, picture, drawing, a color, etc.), an audio message, information specifying the emission of a substance whose scent/fragrance or taste can be sensed (smelled and/or tasted), a video message, a multimedia message, and any other module of comprising data instances collectively adapted for presentation to a user by way of an electronic interactive device. Each cell preferably comprises a definable area of a display whereupon activation results in one or more actions such as those that follow: ordering an item, deleting an item, controlling a peripheral, navigating though dialog, controlling an internal dialog process, controlling an external process, and/or presenting at least one of the objects. All types of cells are contemplated herein including cells that merely present the object for viewing, or other experience (touch, taste, smell, hearing), item order cells, item delete cells, item family-screen branch cells [e.g., items may be categorized by way of menu, including submenu(s) of related items, or other family category], general cells not necessarily associated with an item such as an EXIT or CANCEL Order cell, overflow-screen branch cells, and hidden-screen branch cells. Accordingly during the authoring of a presentation, presentation object(s) are accessed and used such that they preferably fit within the cell selected (based on its functionality) for presentation at the interactive device.

Additional distinguishing features are many: a DIALOG template, preferably having at least one file or other collection of records, may be provided containing the first template, as well as additional templates, each defining respective first, second, third, and so on, default patterns. In an effort to organize the various types of information intended for presentation at an interactive device, namely, cells and any characteristics assigned thereto, presentation objects, common display areas/features, and so on, each default pattern of each of the first, second, and third template is preferably associated with a respective parent group(ing). Further grouping may be done by identifying one or more subgroup(ing)s each tied, for example, to a display area within a default pattern/parent group (examples include window display and button/cell display areas defined to contain cells/features sharing common characteristics). At least one cell is preferably associated with each subgroup, although more than one cell may be so associated depending upon layout of that subgroup's display area. Further (as discussed below), an assignment of cell characteristics may be further made for each identified subgroup(s) of cells. To fill-in cells with respective presentation objects after reading respective default pattern(s) along with accessing group and local presentation information data structure(s) according to the invention, where subgroups have been identified in the group information, the local presentation information preferably further associates each presentation object with a respective identified subgroup.

In providing group information, an assignment of cell characteristics with cells may be done on a variety of levels, such as: to cells associated with a parent group(ing) made of a respective default pattern; to each of the cells assigned to a subgroup associated with display areas of any default pattern; or simply to each cell, whether pre-associated to a parent, subgroup, sub-subgroup. Cell characteristics, as contemplated, is used herein in reference to any of a number of characteristics including cell functions, multisensory attributes, and cell layout patterns. As mentioned, the cell may function to perform any one or more of a multitude of possibilities, upon activation, such as: ordering an item, deleting an item, controlling a peripheral, navigating though dialog, controlling an internal dialog process, controlling an external process, and presenting at least one of the objects. Multisensory attributes, as contemplated, is used herein in reference to any information provided by the cell which can be received by any one or more of the human senses of vision, hearing, touch, smell or taste.

As one will appreciate, there are many further distinguishing features of the process, system, and associated program code of the invention. For example, to provide more control by a ‘local level’ (e.g., in-store, regional headquarters, subsidiary location, etc.) over a presentation, another unique feature may be employed: Where one or more initial cell characteristic(s) is assigned within an initial or edited group information data structure(s), and also one or more local (e.g., in-store) cell characteristic is assigned to a cell or group within the local presentation data structure(s), preferably the cell characteristic(s) of the initial or edited group information is overridden by any such local cell characteristic(s) so assigned for which there is an overlap. In this case, those cell characteristics assigned by or at the local level are, thus, used in connection with filling-in cells used in the presentation. Additionally unique to the instant invention is group information and/or local presentation information editing capability that permits editing, based upon a level of access granted to do so, anywhere along the process but before configuring a final presentation. For example, that level of access to edit information may be high in the case of access by well-trained product support technicians to edit information anywhere along the process but before final configuring; while the level of access will be lower (thus, more-restricted) for in-store management personnel who are given access to local presentation information to carry out editing such as to add menu items, change menu items, change group and/or subgrouping(s) of cells, edit selected cell characteristics (which will override overlapping cell characteristics specified in the group information data structure(s)), and so on. Filling-in of cells of template patterns for which group information has been accessed, may be performed by populating each cell with any respective one or more presentation object according to the data records of the local presentation information. This, then, permits an automatic generating of the presentation, having been tailored for an interactive kiosk at a specific facility (e.g., store-specific presentation).

DIALOG template files may be created to include a multitude of templates (for example, a first, second, and third template), each defining respective default patterns for use in connection with providing initial group information—associating at least one cell to each of a plurality of groups. It may be convenient or useful to create and store for later access and/or use (as ‘intermediary’ type data structures), respective first, second, and third intermediary display patterns—each having been created by reading a respective default pattern along with accessing initial group information such that each of the first, second, and third intermediary display pattern is given the cell-to-subgroup associations of the respective first, second, or third default pattern used to create it. The intermediary display patterns may be created just after group information is provided (at for example a first location) or may be created some time later in the process but before filling-in cells for the presentation (at for example a second location). Any suitable data structure, based upon storage capability and location, may be employed in connection with creating intermediary display pattern(s).

Any one of more of the intermediary display patterns may be read, along with group information and local presentation information, such that the step of filling-in is performed on cells of the selected intermediary patterns. Copying intermediary patterns may provide convenience by producing instantiations, or instances/copies, of selected patterns for which cell (sub)groups have already been assigned by way of the group information. Thus, the step of filling-in, preferably occurring in-store (once again for example, this may be at the front door, near a front desk, self-standing, attached to another structure, along the path of or at a drive-through order window, or within any restaurant, outlet, shop, hotel/motel, grocery store, mall, bank/institution, airport, bus/train station, library, government building or access, as well as other public or private facilities where items may be ordered)—such as at a second location—may include populating cells of each selected intermediary display pattern read, as well as cells of each instantiation display pattern(s) read, with any one or more respective presentation object according to the data records of the local presentation information.

In another aspect of the invention a system for authoring electronic information for presentation at an interactive electronic display with which an item may be ordered is contemplated. Here, a DIALOG template comprising at least a first template defining a default pattern, group information comprising data records associating at least one cell to each of a plurality of identified groups, and local presentation information comprising data records associating each of a plurality of presentation objects with at least one of the identified groups, are combined with a processor adapted for filling-in cells, after reading the default pattern and accessing the group and local presentation information. The unique features detailed above are appropriately carried out to further distinguish a system of the invention from assignee's earlier patented configuration method, as well as any conventional techniques. The DIALOG template can originate at a first location, such as a host type computer system with sufficient memory and storage located off-site from where the presentation will be made for ordering items. This first location may be as close as an upper- or basement floor of a building storefront, next door thereto, or a ‘backroom’ office, or as far away as another region or country.

In yet another aspect of the invention, a computer executable program code on a computer readable storage medium, as characterized includes: a first program sub-code for providing at least a first template defining a default pattern; a second program sub-code for creating group information comprising data records associating at least one cell to each of a plurality of identified groups; a third program sub-code for providing local presentation information comprising data records associating each of a plurality of presentation objects with at least one of said identified groups; and a fourth program sub-code for reading said default pattern, accessing said initial group information and said local presentation information, and filling-in said cells.

The second program sub-code can comprise instructions for: (a) assigning a cell characteristic selected from the group consisting of, for example, cell functions, multisensory attributes, and cell layout patterns; (b) identifying a first and second subgroup for any one or more parent groups identified, wherein the first subgroup is associated with a first display area of the default pattern, the second subgroup associated with a second display area of the default pattern; (c) further associating at least one cell with each of the subgroups. The third program sub-code can comprise instructions for further associating each presentation object with one of the identified subgroups.

Furthermore, additional program sub-code(s) may be employed in a variety of combinations, for: (a) permitting editing of the group information, based upon a level of access granted to do so, before reading the default pattern and filling-in cells; (b) permitting editing of the local presentation information, based upon a more-restricted level of access granted to do so, before said step of reading said default pattern and filling-in said cells; (c) creating an intermediary display pattern at a first location using the default pattern and the group information such that the intermediary display pattern is given the cell-to-group associations of the default pattern—wherein further instructions may be provided for reading the intermediary pattern and filling-in each cell with any one or more respective presentation object according to data records of the local presentation information; and (d) for generating the presentation at an interactive kiosk at a second (in-store, for example) location.

### BRIEF DESCRIPTION OF THE DRAWINGS

For purposes of illustrating the innovative nature plus the flexibility of design and versatility of the preferred technique and system, and associated program code, supported and disclosed hereby, the invention will be better appreciated by reviewing the accompanying drawings (in which like numerals, if included, designate like parts). One can appreciate the many features that distinguish the instant invention from known, including the assignee's prior patented configuration method and traditional techniques. The drawings and any attachments hereto have been included to communicate the features of the innovative system and associated technique of the invention as well as the rigorous analysis performed by the applicants by way of example, only, and are in no way intended to unduly limit the disclosure hereof.

FIG. 1 is a schematic block diagram of system hardware features, connected in a manner designed by the assignee hereof and as illustrated in assignee's U.S. Pat. No. 5,806,071, which may be employed for transmitting and presenting a store-specific multi-media type display of consumable and nonconsumable items for sale to a user at a terminal (with which an order may be placed).

FIG. 2 is a schematic block diagram representing features of a preferred system 40 of the invention—depicted on either side of the vertical dashed line are components adapted for operation at separate physical processing units/locations, as labeled: host location and in-store location.

FIG. 3 is a schematic representation of one example of a group information data structure 99 generated for subgroups (track) 1 and 2, respectively associated with display areas ControlBtn and ItemBtn, for an example parent group I labeled “MYSCREEN” by operation of a group information generator 98 feature.

FIG. 4 is a pictorial representation of template default pattern 142 for which four display areas have been logically defined as boundaries (144, 145, 146, 147) drawn around groups of cell location possibilities. Sub-subgroups are also identified and represented.

FIG. 5 is a pictorial representation of template pattern 142′ with a button/cell display area defined and labeled 144′; copies of pattern 142′ are shown as instantiations 154, 156, 158.

FIG. 6A-6C are pictorials of, respectively, screen displays 162, 172, 182 by way of example only. The display (labeled 162, 172, 182) represent presentation displays authored according to the invention.

FIG. 7 is a flow diagram depicting details of a process 200 for authoring electronic information for presentation at an interactive electronic display with which an item may be ordered according to the invention. Illustrated are core, as well as further unique and distinguishing features, for utilizing technology represented in FIGS. 2-5 to author presentations such as those represented and depicted in FIGS. 6A-6C.

### DETAILED DESCRIPTION OF EMBODIMENTS DEPICTED IN DRAWINGS

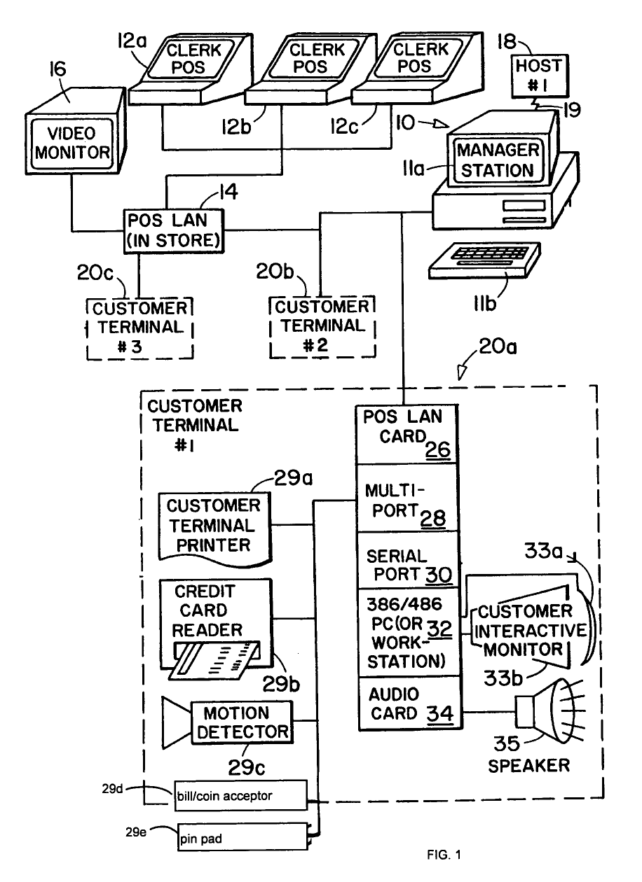

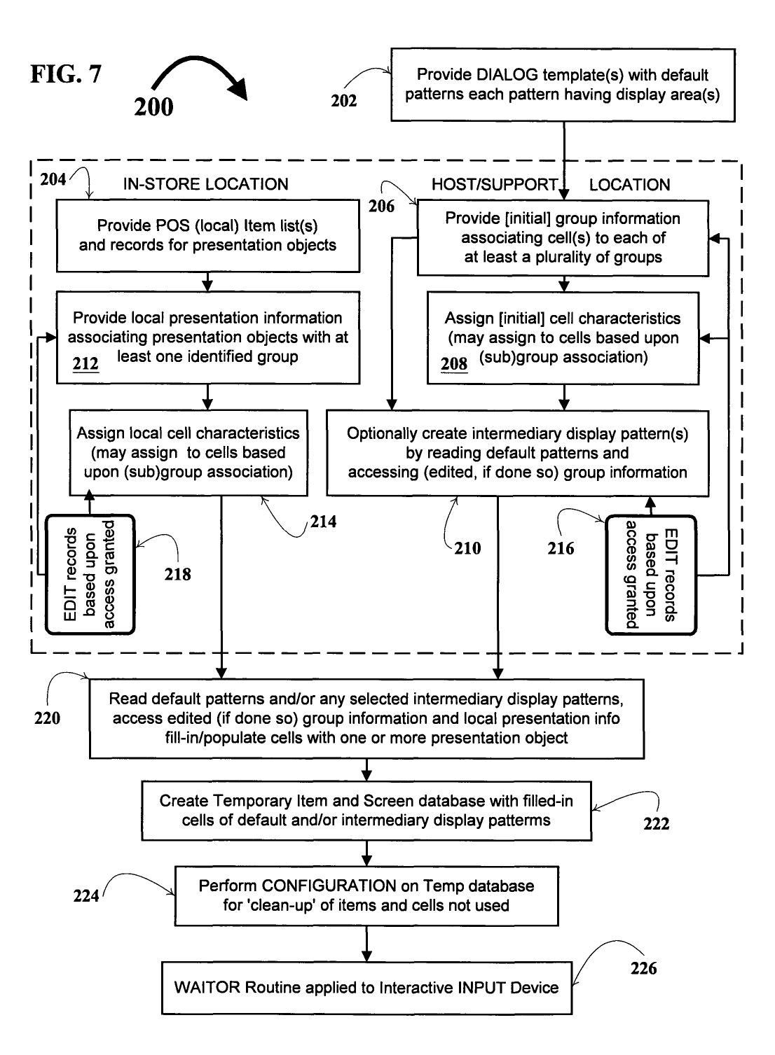

In connection with discussing FIGS. 1-6A through 6C, occasional reference will be made to the FIG. 7 flow diagram detailing at 200 core, as well as further unique and distinguishing features of a technique of the invention. FIG. 1 is provided by way of background reference. Host #1 box 18 represents a computer (such as a personal computer, workstation, or mainframe) located at, for example, management headquarters of a company having many sales outlets. Line 19 connects box 18 to the manager's station 10 (such as a personal computer, workstation, mainframe computer, etc.). This represents the communication medium through which management headquarters and the outlet manager can “talk”. Together, Host #2 at 24 and line 23 connecting it (through connection Box 22) to customer terminals 20a, 20b, 20c, represent a computer system 24 (a personal computer, workstation, mainframe computer, etc.) and communication medium 23 through which a multi-media presentation, and its updates, can be transmitted. Known communication systems can be used for the transmission and receiving of electronic information from Host processor 18 to manager's station 10 and customer terminals 20a, 20b, 20c. Transmission media suitable for use to connect head-quarters Host 18 with manager's station 10 includes telephone line(s) connected at each end to a modem (or other hardwired system), full-duplex Wide Area Network wiring, TCP/IP or web connection, or any other means by which electronic information may be delivered to an outlet.

As is well known, each customer terminal 20a, 20b, 20c, the manager's station 10 (operated by, or at the direction of, the outlet's management), each Point-of-Sale (POS) terminal 12a, 12b, 12c (suitable POS systems include model 3230 from PAR Microsystems Corp.) used by the clerks who take orders in-person at an outlet front or back counter (or drive-through window), and the video monitor 16 (located where stock is pulled for satisfying an order—such as the restaurant kitchen), are all connected to a known POS Local Area Network (LAN) 14 within the outlet. Suitable LANs include an ethernet, arcnet, RS-485, or RS-232 LAN. It is preferred that the customer terminals 20a, 20b, 20c and clerk-operated POS terminals 12a, 12b, 12c be connected to the backroom video monitor 16 so that an order can be communicated to the person pulling items from stock for delivery to a customer. The manager's station 10 is, oftentimes, also connected to the customer and clerk POS terminals so that data pertaining to inventory levels, revenue, sales, purchase trends, etc., can be collected and analyzed for use at the outlet and headquarters. Manager's station 10 is shown with a monitor 11a and key board 11b so that information can be entered via touch-screen or key board. Dashed-line box 20a (representing a customer terminal), encompasses one example of a typical hardware set up (including peripherals) currently being commercially used in the fast-food industry. In-store POS LAN 14 is connected through a POS LAN card 26.

The customer terminal includes a multi-port connection, represented by box 28, which communicates with peripherals such as a printer 29a, credit card reader 29b, motion/proximity detector 29c, a cash (bill and/or change) acceptor 29d, and pin pad 29e. Also included is a serial port connector, represented by box 30. Connected to the processor 32 (such as Intel Corporation's PENTIUM® processors commercially available and used widely) is a monitor 33b (such as a XGA-compatible monitor available from Toshiba, Sharp, and others) having a touch-screen display 33a. Audio card 34 allows for connection with a speaker that can relay sound messages to a customer. Although not shown, a microphone could be also connected to the customer terminal system 20a so that audio messages from the customer could be fed into a transducer for transmission through the in-store POS LAN 14 to the clerk POS terminals 12a, 12b, 12c or inventory video monitor 16.

As it is well known, a digital computer (like those at 10, 18, 24, 20a) typically consists of a central processing unit (CPU), memory (usually with three storage elements: instructional storage, a program storage, and data storage), and several peripherals (examples: magnetic disk, printer, mouse, all attached through I/O ports). Optionally, a second host #2 (not shown) may be utilized. The customer terminals (20a, 20b, 20c), although shown in more detail at 20a to have individual processing units, can be replaced with a single processor connected to several customer presentation devices. Electronic devices suitable for use include: a touch-screen on a Cathode Ray Tube CRT monitor, a flat-panel Liquid Crystal Display LCD screen, or a Light Emitting Diode LED screen; a computer key board; a telephone key-pad or receiver; or a microphone. Likewise, each clerk POS terminal (12a, 12b, 12c) could have its own processor, or a single POS processor could be connected to several devices capable of accepting a clerk's input.

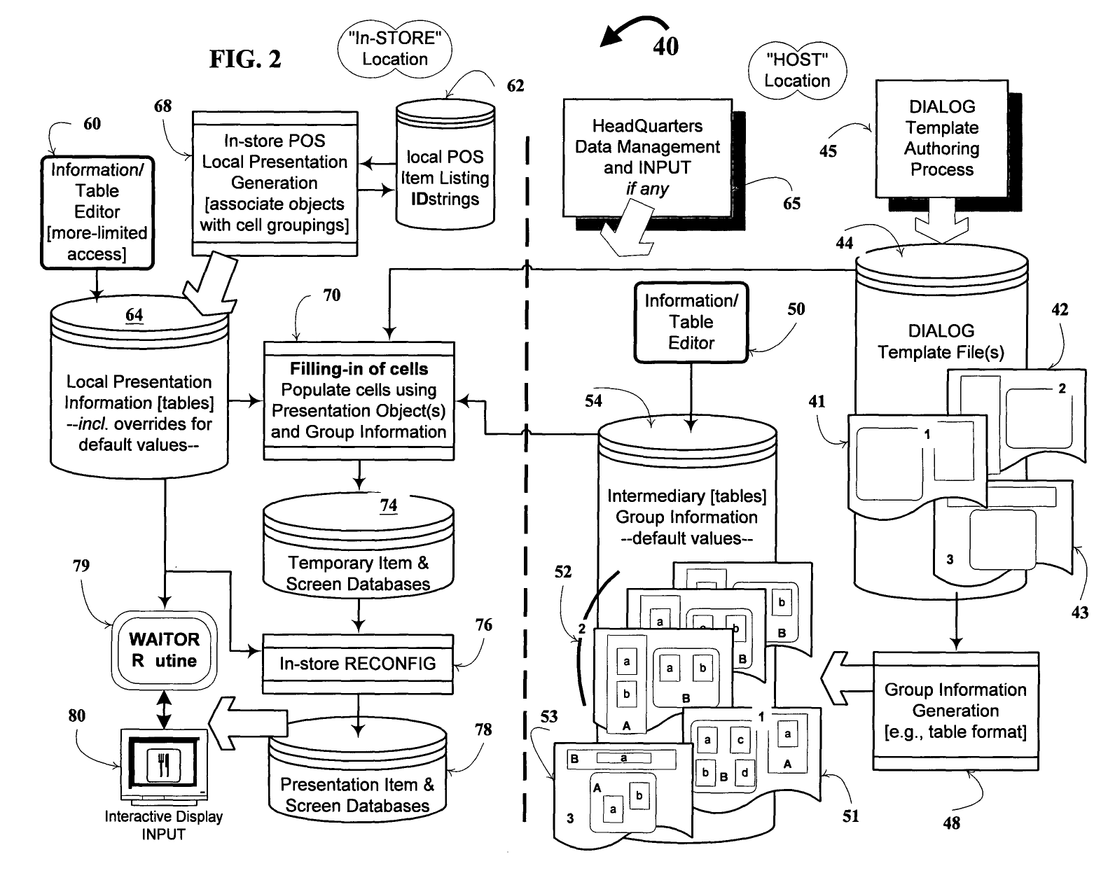

FIG. 2 is a schematic block diagram representing features of a preferred system 40 of the invention—depicted on either side of the vertical dashed line central to FIG. 2 are components adapted for operation at separate physical processing units/locations, as labeled: “HOST” location and “In-STORE” location. Unique to applicants' invention, DIALOG template file(s), at 44, need not contain the following, as these will be provided in the local presentation information data structure(s): a listing of items for sale and associated presentation objects. But rather, the DIALOG template preferably contains one or more default pattern(s)/layout(s) for screens as well as cell location possibilities; and the DIALOG template file(s) may further contain: cell characteristics, and associated instructions, such as for icons, graphics, text, and audio messages, etc., and for cell types such as branch menu cells (which point to/call-up associated ordering screens), standard branch cells (to call-up a previous or later screen), and overflow and hidden branch cells (which point to overflow or hidden screens only seen if certain conditions have been met). Suitable dialog files creator functionality may be used to initially create 45 dialog control files for DIALOG template 44 that: (a) control overall sequencing of template patterns; (b) define default parameters for presentation screen displays; as well as (c) specify when special functions take place. Suitable editors may be employed for use in connection with generating the local presentation information 64. By way of example, suitable graphics editor functionality may be carried out by any graphics image editor that can create digital graphic files (such as well known PCX, PCC, GIF, or TIF files) for graphic and icon display images. There are many available graphics and icon creation tools suitable for use including Adobe's “PHOTOSHOP”. Suitable audio editor may be used for producing files compatible with audio cards (34 in FIG. 1) used in the customer terminal (for example, if a sound chip is used, or one can use an audio editing tool is called “WaveEditor” supplied by MICROSOFT).

As shown DIALOG template 44 has first, second, and third templates defining a default pattern pictorially represented at 41, 42, and 43. Group information comprising data records associating at least one cell to each of a plurality of identified groups (e.g., 51, 52, 53), and local presentation information (64) comprising data records associating each of a plurality of presentation objects with at least one of the identified groups, are processed to fill-in cells (70). As mentioned, the DIALOG template can originate at a first location, such as a host type computer system with sufficient memory and storage located off-site from where the presentation will be made for ordering items (by way of example, right hand side of dashed line in FIG. 2 is labeled HOST Location separated from the region labeled IN-STORE Location, for reference). This first location may be as close as an upper- or basement floor of a building storefront, next door thereto, or a ‘backroom’ office, or as far away as another region or country, whereby transmission of the default patterns for which grouping(s) have been identified utilizing the group information generation functionality/module to an in-store location may be via cable, hardwire, or RF transmission for host locations close to the in-store presentation, or may be via satellite, Wide Area Network (WAN)—including Internet, suitable Local Area Network (LAN), as well as copying and storing the information on traditional storage media including any of the known computer readable storage device technologies, including those traditionally built as part of a computer system (e.g., hard drive) as well as removable media.

Referring to both FIGS. 2 and 7, in an effort to organize the various types of information intended for presentation at an interactive device, namely, cells and any characteristics assigned thereto, presentation objects, common display areas/features, and so on, each default pattern of each of the first, second, and third template is preferably associated with a respective parent group(ing), pictorially represented at 41, 42, 43 and boxes 202, 206. As one can see, further grouping may be done by identifying one or more subgroup(ing)s each tied, for example, to a display area within a default pattern/parent group (examples include window display and button/cell display areas defined to contain cells/features sharing common characteristics), box 206. At least one cell is preferably associated with each subgroup, although more than one cell may be so associated depending upon layout of that subgroup's display area; pictorially represented at is 51, 52, 53. Further, an assignment of cell characteristics may be further made for each identified subgroup(s) of cells, box 208. To fill-in cells with respective presentation objects after reading respective default pattern(s) along with accessing group and local presentation information data structure(s) according to the invention (at 70 and box 220), where subgroups have been identified in the group information, the local presentation information preferably further associates each presentation object with a respective identified subgroup (68, 64 and box 212).

In providing group information, an assignment of cell characteristics with cells may be done on a variety of levels, boxes 208 and 214) such as: to cells associated with a parent group(ing) made of a respective default pattern; to each of the cells assigned to a subgroup associated with display areas of any default pattern; or simply to each cell, whether pre-associated to a parent, subgroup, sub-subgroup. Cell characteristics, as contemplated, is used herein in reference to any of a number of characteristics including cell functions, multisensory attributes, and cell layout patterns. As mentioned, the cell may function to perform any one or more of a multitude of possibilities, upon activation, such as: ordering an item, deleting an item, controlling a peripheral, navigating though dialog, controlling an internal dialog process, controlling an external process, and presenting at least one of the objects. Multisensory attributes, as contemplated, is used herein in reference to any information provided by the cell which can be received by any one or more of the human senses of vision, hearing, touch, smell or taste.

It may be convenient or useful to create and store for later access and/or use (as ‘intermediary’ type data structures), respective first, second, and third intermediary display patterns (for reference see FIG. 7 box 210, which may take place at either a HOST or IN-STORE Location). Each intermediary display pattern may be created by reading a respective default pattern along with accessing initial group information such that each of the first, second, and third intermediary display pattern is given the cell-to-subgroup associations of the respective first, second, or third default pattern used to create it (for reference see FIG. 2 at 51, 52, 53, and 54). The intermediary display patterns may be created just after group information is provided (at for example a first location) or may be created some time later in the process but before filling-in cells for the presentation (at for example a second location). Any suitable data structure, based upon storage capability and location, may be employed in connection with creating intermediary display pattern(s).

Referring to FIG. 7 by way of example, to provide more control by a ‘local level’ (e.g., in-store, regional headquarters 65, subsidiary location, etc.) over a presentation, another unique feature may be employed: Where one or more initial cell characteristic(s) is assigned within an initial or edited group information data structure(s), box 208, and also one or more local (e.g., in-store) cell characteristic is assigned to a cell or group within the local presentation data structure(s), box 214, preferably the cell characteristic(s) of the initial or edited group information (box 208) is overridden by any such local cell characteristic(s) so assigned (box 214) for which there is an overlap. Thus, those cell characteristics assigned by or at the local level are used in connection with filling-in cells for the presentation. Additionally unique to the instant invention is group information and/or local presentation information editing capability that permits editing, based upon a level of access granted to do so, anywhere along the process but before configuring a final presentation; for reference see FIG. 2 at 50 and 60 and FIG. 7 at 216 and 218. For example, that level of access to edit information may be high in the case of access by well-trained product support technicians to edit information anywhere along the process but before final configuring (at 50 and box 216); while the level of access will be lower (thus, more-restricted) for in-store management personnel who are given access to local presentation information (at 60 and box 218) to carry out editing such as to add menu items, change menu items, change group and/or subgrouping(s) of cells, edit selected cell characteristics (which may override overlapping cell characteristics specified in the group information data structure(s)), and so on. This unique override feature may be activated throughout the process of the invention such that personnel with varying levels of decision-making authority may be granted various levels of override authorization. For example, corporate headquarters may have the highest override authorization level such that any cell characteristics it edits (e.g., at 50 or at 60, FIG. 2) will override edits made by sales retail outlet (e.g., at 60, FIG. 2) of overlapping data. Filling-in of cells of template patterns for which group information has been accessed (at 70 and box 220), may be performed by lo populating each cell with any respective one or more presentation object according to the data records of the local presentation information (for reference see 60, 68, 64 of FIG. 2). This, then, permits an automatic generating of the presentation 78, having been tailored for an interactive kiosk such as that at 80 at a specific facility.

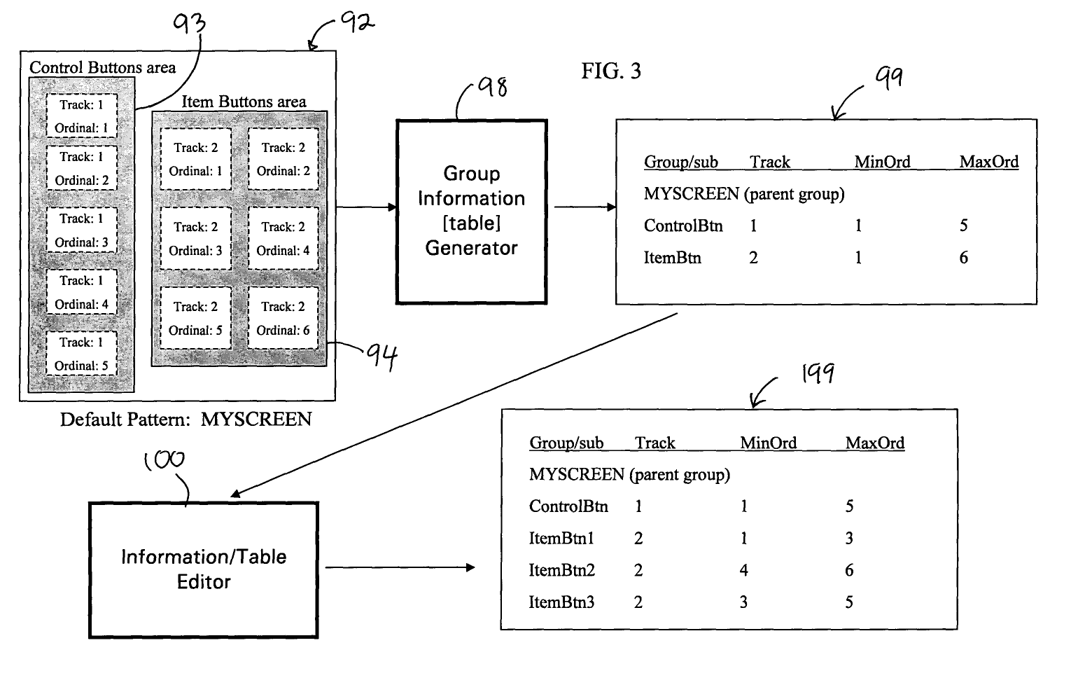

After a temporary presentation has been authored (at 74 and box 222), assignee's earlier patented CONFIGURATION/RECONFIG technique may be employed (at 76 and box 224) as a ‘clean up’ measure to remove items not available for sale on a particular given day and/or cell locations or branching not needed in order to present the tailor-made presentation authored. The output of CONFIGURATION (at 78 and 224)—for further reference see assignee's U.S. Pat. No. '071 FIG. 3—is then sent through a routine identified as WAITOR 79 for final presentation to a user at the interactive display 80.

The example depicted in FIG. 3 represents a group information data structure 99 which has been generated 98 (for further reference see also FIG. 2 at 48 and FIG. 7 box 206) for subgroups (track) 1 and 2, respectively associated with display areas ControlBtn and ItemBtn, for an example parent group I labeled “MYSCREEN”. After operation of a group information generator 98 feature, the data 99 is edited by operation of an editing functionality 100, so that the group information becomes an edited data structure 199. As can be appreciated, data structure 199 now has two additional subgroups. For further reference concerning tracks and ordinals, please see FIG. 7 of assignee's U.S. Pat. No. 5,806,071 ('071) depicting one embodiment of a “cell” layout/organization possibility: each cell location (shown on the screen, organized in “tracks”) is represented by a box in FIG. 7 of '071.

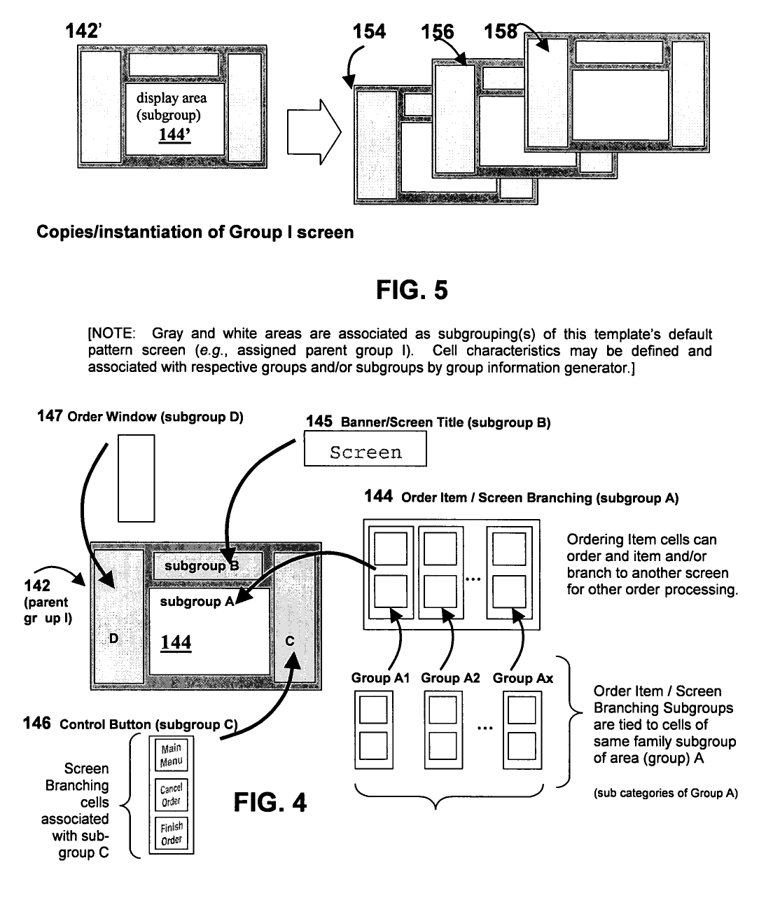

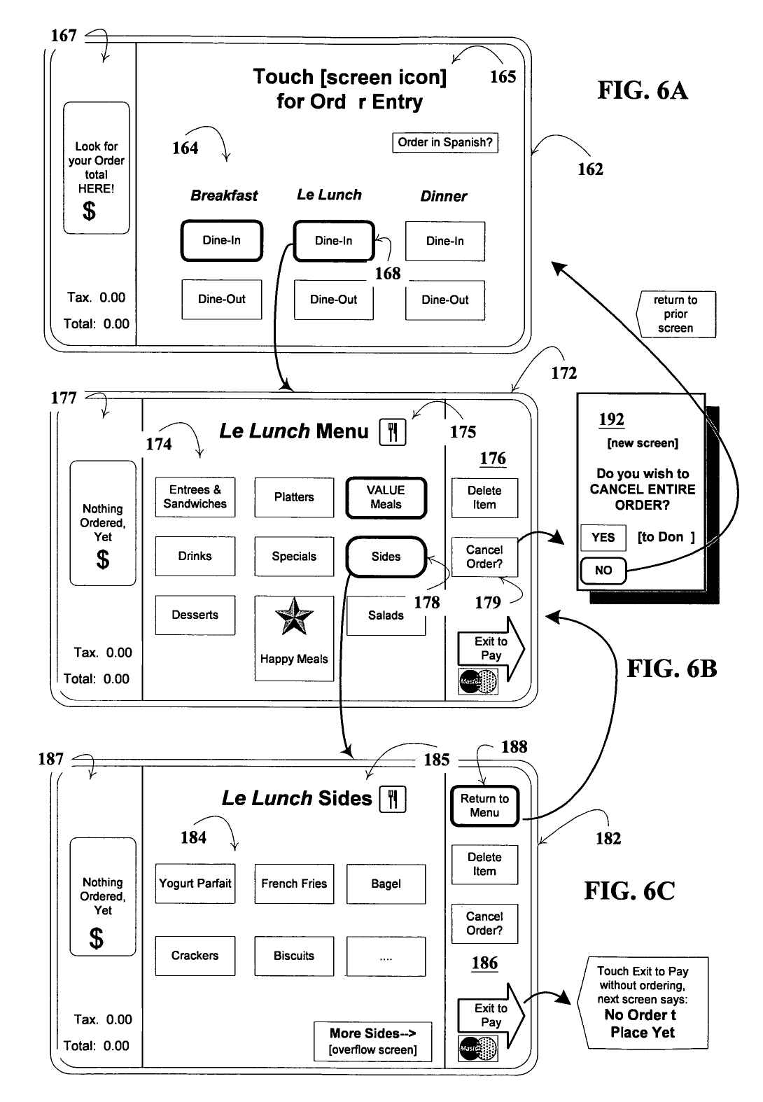

FIG. 4 is a pictorial representation of template default pattern 142 for which four display areas have been logically defined as boundaries (144, 145, 146, 147) drawn around groups of cell location possibilities. In exploded assembly fashion, each of the subgroups A-D associated with respective display areas Order Item/Screen Branching (subgroup A), Banner/Screen Title (subgroup B), Control Button (subgroup C), and Order Window (subgroup D). The group generator functionality (such as that depicted elsewhere as 48 in FIG. 2, at 100 in FIG. 3, and at 206 in FIG. 7) is employed to associate groups and subgroup(ing)s such as those depicted here. The order item cells of subgroup A 144 may, for example, function to branch to another screen display (see also FIG. 6A-C at 168, 178). The cells in subgroup A have been further subdivided into subcategories, for example, of sub-families of items labeled Group A1, A2, . . . Ax, to which a couple of cells have been associated, as shown, as branching cells tied to cells of the same family of items.

TABLE A below itemizes the type of information preferably included in the database records 64 for a particular outlet (e.g., a restaurant). While shown to be located on an in-store computer (left hand side of FIG. 2), this is not necessary. The components that function to generate and maintain local presentation information records and files 62, 68, 60, 64 may be carried out on a computer (such as the manager station 10, one or each of the clerk POS terminals 12a, 12b, 12c, or one or each of the customer terminals 20a, 20b, 20c—all shown in FIG. 1) located within the sales outlet; or the local presentation information records and files may be created on a separate computer from, but at the same building as, the computer used to create the DIALOG template 44. The generating and maintaining of these records and files 62, 68, 60, 64 might also be carried out with the same computerized unit, but created at a different time (e.g., during the day) than when DIALOG template 44 generation is performed (e.g., at night). It is, nevertheless, preferred that the DIALOG template 44 and the local presentation information 64 be created to form separately stored and maintained files and data. This is so that sales outlet personnel (most-likely store managers) can control, if desired, the creation and modifying of their own records (for reference see FIG. 2 at 62, 68, 60, 64) of items and presentation objects they intend to use to sell items over the course of a day, week, month, and so on. Since store/outlet personnel typically prefer using the common name(s) of items for quick recognition of items being included in a database list they are creating for their store. The item common-names are included in TABLE A. Note that local database Price Look-Up (PLU) codes for items are internal and can vary from outlet to outlet. Also shown are parent group and subgroupings so that items, which have been tied/assigned to and any presentation objects that will be employed in the presentation when offering the item for sale using the interactive device (FIG. 2 at 80), may be tied to cell groups during the fill-in/populating of cells with objects (for reference, see FIG. 2 at 70 and FIG. 7 at 220).

TABLE A
(example of, simplified, presentation information data structure)

| name/IDstring = | | |
|---|---|---|
| presentation object(s) | Parent group/subgroup | PLU (other) code |
| HmBur = (animated burger | 1/A1 | 001 |
| graphic) | | |
| ChsBur = (cheese burger | 1/A1 | 002 |
| icon + text) | | |
| ChkSnd = (sandwich icon + | 1/A2 | 003 |
| text) | | |
| HtDog = (still graphic + | 1/A2 | 004 |
| dog icon) | | |
| TunaS = (animated sand- | 1/Ax | 005 |
| wich graphic) | | |
| FishS = (sandwich icon, | 1/Ax | 006 |
| smell, graphic) | | |

FIG. 5 is a pictorial representation of template pattern 142′ with a button/cell display area defined and labeled 144′; copies of pattern 142′ are shown as instantiations 154, 156, 158.

FIG. 6A-6C are pictorials of, respectively, screen displays 162, 172, 182 by way of example only. The displays labeled 162, 172, 182 represent presentation displays authored according to the invention. One or more instantiations of any one of displays 172 or 182 could be used to create other similar item ordering screens using the unique method depicted in FIG. 5 (where three instantiations are shown having originated from template pattern 142′). The screens illustrate examples of presentation objects that have been filled into cells of display areas (FIG. 2, 70 and FIG. 7 220) and for which any further functions have been performed (FIG. 2 at 74, 76, 78, 79) in order to present items for sale. Display areas of screen displays 162, 172, 182 are, respectively, as follows: for display 162, areas include 164, 165, and 167 (see, for reference, FIG. 5 at 144, 145, 147); for display 172 areas include 174, 175, 176, 177 (see, for reference again, FIG. 5); and for display 182 areas include 184, 185, 186, 187. Branching occurs by activating cells 168, 178, 179, 188 as shown for reference.

Once again, and as referenced throughout this disclosure, the unique features depicted in FIG. 7, in flow diagram format, detail a process 200 for authoring electronic information for presentation at an interactive electronic display with which an item may be ordered, according to the invention. Illustrated are core, as well as further unique and distinguishing features, for utilizing technology represented in FIGS. 2-5 to author presentations such as those represented and depicted in FIGS. 6A-6C.

While certain representative embodiments and details have been shown for the purpose of illustrating the invention, those skilled in the art will readily appreciate that various modifications, whether specifically or expressly identified herein, may be made to any of the representative embodiments without departing from the novel teachings or scope of this technical disclosure. Accordingly, all such modifications are contemplated and intended to be included within the scope of the claims. Although the commonly employed preamble phrase “comprising the steps of” may be used herein in a method claim, applicants do not intend to invoke 35 U.S.C. §112 ¶6. Furthermore, in any claim that is filed herewith or hereafter, any means-plus-function clauses used, or later found to be present, are intended to cover at least all structure(s) described herein as performing the recited function and not only structural equivalents but also equivalent structures.

What is claimed is:

1. A process for authoring electronic information for presentation at an interactive electronic display with which an item may be ordered, comprising the steps of:
providing at least a first template defining a default pattern;
providing group information comprising data records associating at least one cell to each of a plurality of identified groups;
providing local presentation information comprising data records associating each of a plurality of presentation objects with at least one of said identified groups; and
reading said default pattern along with accessing said group information and said local presentation information, filling-in said cells.

2. The process of claim 1 wherein:
said step of providing group information further comprises optionally assigning cell characteristics;
said group information is organized as a data structure;
said presentation information is organized as a data structure;
each of said plurality of presentation objects comprises at least one module of data having multisensory attributes; and
each of said cells comprises a defined area of a display whereupon activation results in at least one action selected from the group consisting of ordering an item, deleting an item, controlling a peripheral, navigating though dialog, controlling an internal dialog process, controlling an external process, and presenting at least one of said objects.

3. The process of claim 1 wherein:
said step of providing at least a first template further comprises providing a DIALOG template to include said first template and a second and third template, each defining a respective second and third default pattern; and
said step of providing group information further comprises assigning cell characteristics, and said cell characteristics comprises a characteristic selected from the group consisting of cell functions, multisensory attributes, and cell layout patterns.

4. The process of claim 3 wherein:
said group information is organized as a data structure;
said identified groups comprise a first, second, and third parent group, each respectively associated with said first, second, and third template; and
said step of providing group information further comprises identifying at least a first and second subgroup for each of said parent groups.

5. The process of claim 4 wherein:
said step of providing group information further comprises associating each of said first and second display areas with a respective one of said identified subgroups, associating at least one cell to each of said identified subgroups, and said assigning cell characteristics comprises doing so for each of said identified subgroups of cells; and
said step of providing local presentation information comprises further associating each said presentation object with one of said identified subgroups.

6. The process of claim 1:
wherein said step of providing group information further comprises assigning initial cell characteristics;
wherein said step of providing local presentation information further comprises assigning local cell characteristics to any of said cells; and
further comprising the step of, after said accessing of said group information and said local presentation information, overriding any of said initial cell characteristics of said group information with any of said local cell characteristics for which there is an overlap.

7. The process of claim 6 wherein:
said initial cell characteristics comprise a characteristic selected from the group consisting of cell functions, multisensory attributes, and cell layout patterns; and
said step of filling-in comprises populating each said cell with any respective of said presentation objects according to said data records of said local presentation information to generate the presentation at an interactive kiosk.

8. The process of claim 1 wherein:
said identified groups comprise (a) a first parent group associated with said first template, and (b) a second parent group associated with a second template defining a second default pattern; and
said step of providing group information further comprises:
identifying at least a first and second subgroup for each of said parent groups;
associating each of a first and second display area of said first default pattern with a respective first- and second-subgroup of said first parent group;
associating each of a first and second display area of said second default pattern with a respective first-and second-subgroup of said second parent group; and
associating a plurality of cells respectively with each of said subgroups.

9. The process of claim 8 wherein:
said step of providing group information further comprises assigning cell characteristics for each of said parent groups; and
said step of providing local presentation information comprises further associating each said presentation object with one of said subgroups.

10. The process of claim 9 wherein said step of providing group information further comprises assigning cell characteristics for each of said plurality of cells associated with said subgroups; and further comprising, after said step of providing group information and before said step of reading said default pattern, the step of editing said group information, based upon a level of access granted to do so.

11. The process of claim 8 wherein each of said plurality of presentation objects comprises at least one module of data having multisensory attributes; and further comprising the step of, reading said first and second default pattern along with accessing said group information and creating a respective first and second intermediary display pattern such that each said first and second intermediary display pattern has said cell-to-subgroup associations of said respective first and second default pattern.

12. The process of claim 11 further comprising the step of copying and storing said second intermediary display pattern as a plurality of instantiation second display patterns; and wherein:
said creating said first and second intermediary display patterns occurs at a first location;
said step of reading said default pattern further comprises reading said first and second intermediary pattern and each of said instantiation second display patterns; and
said step of filling-in comprises, at a second location, populating each said cell of said first and second intermediary display patterns and each of said instantiation second display patterns with any respective of said presentation objects according to said data records of said local presentation information.

13. A process for authoring electronic information for presentation at an interactive electronic display with which an item may be ordered, comprising the steps of:
providing at least a first template defining a default pattern having a first and second display area;
providing initial group information comprising data records associating at least one cell to each of a subgroup associated with each said first and second display area;
editing said initial group information, based upon a level of access granted to do so;
providing local presentation information comprising data records associating each of a plurality of presentation objects with at least one of said subgroups; and
reading said first and second default patterns along with accessing said edited group information and said local presentation information, populating each said cell with any respective of said presentation objects according to said data records of said local presentation information.

14. A system for authoring electronic information for presentation at an interactive electronic display with which an item may be ordered, the system comprising:
a DIALOG template comprising at least a first template defining a default pattern;
group information comprising data records associating at least one cell to each of a plurality of identified groups;
local presentation information comprising data records associating each of a plurality of presentation objects with at least one of said identified groups; and
a processor adapted for, after reading said default pattern and accessing said group information and said local presentation information, filling-in said cells.

15. The system of claim 14 wherein:
said first default pattern defines at least a first and second display area;
said DIALOG template further comprises a second and third template respectively defining a second and third default pattern, each of which has first and second display areas;
said identified groups comprise a first, second, and third parent group, each respectively associated with said first, second, and third template; and
said data records of said group information further identify a first and second subgroup for each of said parent groups.

16. The system of claim 14 wherein:
said DIALOG template originates at a first location and said processor is at a second location;
said group information is organized as a data structure;
said presentation information is organized as a data structure;
each of said plurality of presentation objects comprises at least one module of data having multisensory attributes; and
each of said cells comprises a defined area of a display whereupon activation results in at least one action selected from the group consisting of ordering an item, deleting an item, controlling a peripheral, navigating though dialog, controlling an internal dialog process, controlling an external process, and presenting at least one of said objects.

17. The system of claim 14 further comprising an interactive display adapted for viewing the presentation; and wherein:
said data records of said group information further associate initial cell characteristics for each said cell;
said data records of said local presentation information further associate local cell characteristics to each said cell; and
said filling-in comprises populating each said cell with any respective of said presentation objects according to said data records of said local presentation information, and such that said local cell characteristics override any of said initial cell characteristics for which there is an overlap.

18. The system of claim 14 further comprising a second processor adapted for permitting editing, based upon a second level of access granted to do so, of said group information; and wherein said first processor is further adapted for permitting editing, based upon a first level of access granted to do so, of said local presentation information, said first level of access being more-restricted than said second level.

19. The system of claim 14 further comprising an intermediary display pattern created at a first location using said default pattern and having accessed said group information such that said intermediary display pattern has said cell-to-group associations of said default pattern; and wherein:
said processor is at a store location, said default pattern read for said filling-in said cells is said intermediary display pattern;
said identified groups comprise (a) a first parent group associated with said first template, and (b) a second parent group associated with a second template defining a second default pattern;
said data records of said group information further identify at least a first and second subgroup for each of said parent groups, and further associate at least one cell with each of said subgroups; and
said data records of said local presentation information further associate each said presentation object with one of said identified subgroups.

20. A computer executable program code on a computer readable storage medium for authoring electronic information for presentation at an interactive electronic display with which an item may be ordered, the program code comprising:
a first program sub-code for providing at least a first template defining a default pattern;
a second program sub-code for creating group information comprising data records associating at least one cell to each of a plurality of identified groups;
a third program sub-code for providing local presentation information comprising data records associating each of a plurality of presentation objects with at least one of said identified groups; and
a fourth program sub-code for reading said default pattern, accessing said initial group information and said local presentation information, and filling-in said cells.

21. The program code of claim 20 wherein said second program sub-code further comprises assigning a cell characteristic, said cell characteristic comprising a characteristic selected from the group consisting of cell functions, multisensory attributes, and cell layout patterns; and further comprising:
a fifth program sub-code permitting editing of said group information, based upon a first level of access granted to do so, before said step of reading said default pattern and filling-in said cells; and
a sixth program sub-code permitting editing of said local presentation information, based upon a second level of access granted to do so, before said step of reading said default pattern and filling-in said cells.

22. The program code of claim 20 wherein:
said identified groups comprise a first parent group associated with said first template;
said second program sub-code comprises instructions for identifying a first and second subgroup for said parent group, said first subgroup associated with a first display area of said default pattern, said second subgroup associated with a second display area of said default pattern, and further associating at least one cell with each of said subgroups; and
said third program sub-code comprises instructions for further associating each said presentation object with one of said identified subgroups.

23. The program code of claim 20:
further comprising a fifth program sub-code for creating an intermediary display pattern at a first location using said default pattern and said group information such that said intermediary display pattern has said cell-to-group associations of said default pattern;
wherein said fourth program sub-code comprises instructions for reading said intermediary pattern and for filling-in each said cell with any respective of said presentation objects according to said data records of said local presentation information; and
further comprising a sixth program sub-code for generating the presentation at an interactive kiosk at a second location.
